(19) United States
(12) Patent Application Publication
(10) Pub. No.: US 2014/0189498 A1
(43) Pub. Date: Jul. 3, 2014

(54) SYSTEM AND METHOD FOR ENHANCED INTERACTION BETWEEN AN IFRAME OR A WEB PAGE AND AN EMBEDDED IFRAME FROM A DIFFERENT DOMAIN

(71) Applicant: DOUBLE VERIFY INC., New York, NY (US)

(72) Inventors: Alex Liverant, Tel Aviv (IL); Gil Resh, New York, NY (US); Oren Netzer, Wyckoff, NJ (US); Gil Wasserman, Rosh Ha'ayin (IL)

(73) Assignee: DOUBLE VERIFY INC., New York, NY (US)

(21) Appl. No.: 14/200,970

(22) Filed: Mar. 7, 2014

Related U.S. Application Data
(63) Continuation-in-part of application No. PCT/IL2012/000332, filed on Sep. 6, 2012.
(60) Provisional application No. 61/532,132, filed on Sep. 8, 2011.

(51) Int. Cl. G06F 17/22

(52) U.S. Cl. CPC G06F 17/2247
USPC 715/234

(57) ABSTRACT

A method for allowing enhanced interaction between an IFrame or a web page of a website that corresponds to a domain and an embedded IFrame from a different domain. Accordingly, two IFrames from the same domain that are placed on the same page are allowed to run a JavaScript code one on the other. The website is allowed to place a site tag, from a domain different than the web page's domain that provided to the website by a trusted third party on the top page that is not being nested within an IFrame. The site tag that is delivered on the top page is allowed to perform actions on behalf of an ad tag from the same domain that is nested within the IFrames.

### CROSS-REFERENCE TO RELATED APPLICATION(S)

This application is a continuation-in-part of PCT Application No. PCT/IL2012/000332 filed Sep. 6, 2012, which in turn claims the benefit of U.S. Provisional Application No. 61/532,132 filed Sep. 8, 2011. PCT Application No. PCT/IL2012/000332 and U.S. Provisional Application No. 61/532,132 are hereby incorporated by reference in their entirety.

### FIELD OF THE INVENTION

The present invention relates to the field of Internet web-pages. More particularly, the invention relates to a method and system for allowing enhanced interaction between an IFrame or a web page and an embedded IFrame from a different domain without using cookies.

### BACKGROUND OF THE INVENTION

Web pages frequently use a form of HTML code called IFrames (an element of a predetermined size and location on a web page that opens an internal browser to a different domain, for example, a banner), in order to embed third party content onto their pages. The use of IFrames allows the web page to limit the access and control of the third party code over the original web page (this limit is a two way security limit meaning the web page that created the page also cannot access and control the content of the IFrame). However, in some cases, this method is too restrictive and limits the ability of legitimate third party code to execute properly.

Specifically, the following implementation discusses a scenario in which a third party code, for example an advertising code, runs on the page nested in one or more IFrames, and the third party code requires identification of the URL of the web page and additional data on the page, in which it is running. Identification of the page and the additional data is important for taking proper decisions, which advertisement to serve to the web-page. For example, third party advertisement code may decide to serve an advertisement for holiday destinations on a travel site, or another example might be deciding not to serve an advertisement if the web page contains negative content or if there are already too many ads on the page. By using IFrames, the third party code will typically not have access to the top URL. This limits the ability of the third party code to properly decide on the advertisement.

It is an object of the present invention to provide a method, which provides less restrictive access to legitimate third party code through the use of IFrames that had been pre-approved by the web page owner.

It is another object of the present invention to provide a third party with a code access to identify the page URL, the location of the third party content or ad on the page, whether it is in the visible area of the browser, the number of ads on page and any additional data that can be used for taking proper advertisement or content delivery decisions, regardless of how many IFrames it may be nested in, and without using cookies or any other client-side storage.

Other objects and advantages of the invention will become apparent as the description proceeds.

### SUMMARY OF THE INVENTION

The present invention is directed to a method for allowing enhanced interaction between an IFrame or a web page of a website that corresponds to a domain and an embedded IFrame from a different domain. Accordingly, two IFrames from the same domain that are placed on the same page are allowed to run a JavaScript code one on the other. The website is allowed to place a site tag, from a domain different than the web page's domain that provided to the web site by a trusted third party on the top page that is not being nested within an IFrame. Any other code from the trusted third party that is delivered to the top page but is nested within one or more IFrames from different domains, is allowed to communicate with the site tag. The site tag that is delivered on the top page is allowed to perform actions on behalf of the ad tag from the same domain that is nested within the IFrames. The site tag that is delivered on the top page is allowed to perform actions on behalf of the ad tag from the same domain that is nested within the IFrames. These actions cannot otherwise be performed by that ad tag, because of the IFrame configuration.

In one embodiment, the method may comprise the following steps:

a) placing the site tag on all the pages in which the website decided to allow communication;
b) using a first JavaScript code for generating an IFrame with a call to a static HTML file in the domain of the trusted domain;
c) allowing a second JavaScript code from another IFrame of the trusted domain nested within multiple IFrames to interact with the first JavaScript;
c) allowing the site tag to determine the URL of the page of the website;
d) serving an ad tag inside nested IFrames, the ad tag being another snippet of code from the same domain that is embedded down the ad call chain;
e) generating an IFrame with a call to a static HTML file in the trusted domain, the file contains a JavaScript code being capable of accessing the IFrame in the publisher's page; and
f) allowing the site tag to pass the page URL to the ad tag by communicating through the JavaScript.

The site tag may be operable to extract one or more of the following parameters:
the location of the ad on the page;
the identity of the advertisers on the page;
an indication whether the ad is in the visible area of the browser;
the number of ads on page.

In one embodiment, communication between the Site Tag and the Ad Tag is performed by:

a) generating IFrames that belong to the same trusted domain;
b) using JavaScripts for iterating on the parent windows and their IFrames;
c) finding the IFrame window that was created by the tag served on the top page;
d) allowing the JavaScript to access the properties of the IFrame window.

Interaction between IFrames that have the same domain may be performed by the steps of:

a) the client's browser submits a request for a web-page from the publisher;
b) the top page is served to the client's browser;
c) a site tag IFrame, linked to a trusted domain, is generated and placed on the top page;
d) a first nested IFrame being linked to a first domain is embedded into the top page;
e) a second nested IFrame being linked to a second domain is embedded into the first nested IFrame;
f) a third nested IFrame from the same domain as the trusted domain, being an “ad tag”, is embedded into the second nested IFrame;
g) the third IFrame searches of the site tag from the same domain to see if it exists;
h) the site tag and ad tag communicate and the site tag passes information about the page to the ad tag; and
i) the ad tag sends the information back to the server in real-time for collection and logging or for making decisions in real-time, or decisions are made from within the ad tag.

In one aspect, information may be passed between two ad tags on the page.

In another aspect, both ad tags are embedded in IFrames.

In one aspect, both ad tags are embedded in different locations in the IFrame stack and have access to different kinds of information.

The present invention is further directed to a method for allowing communication between entities from a third party domain, comprising the steps of:

a) creating a container (such as a T2T IFrame) for allowing tag-to-tag communication;
b) allowing the ad tag to search for other containers on the page originating from the same domain that could have been created by another tag from the third party; and
c) if an ad tag having a container finds another ad tag with a container on the webpage, allowing the containers to exchange information.

The method may further comprise the steps of:

a) creating a Unique Page View ID (UPVID) number and a creation timestamp, whenever an ad tag loads on a webpage; and
b) using a common Unique Page View ID (UPVID) for all ad tags on the webpage, having the earliest timestamp.

The information passed may be:
a name or ID of the advertiser or campaign, whose ad is delivered;
a common UPVID for all ad tags on page.

### BRIEF DESCRIPTION OF THE DRAWINGS

In the drawings:

FIG. 1 illustrates an example of the layout of a web-page with a site tag on it, with two nested IFrames, according to an embodiment of the invention; and

FIG. 2 illustrates the process for allowing enhanced interaction between IFrames that have the same domain.

### DETAILED DESCRIPTION OF PREFERRED EMBODIMENTS

The present invention suggests a novel communication method that enables two windows (IFrames) from the same domain on the same page (top page) to interact and run a JavaScript code one on the other. The website will place a snippet of code (hereinafter called a “site tag”) provided to the website by a trusted third party on the top page (i.e., a page that is not nested within an IFrame). This way, any other code from that trusted third party that will be delivered to the page, will be able to communicate with that snippet of code, even if it has been delivered within multiple IFrames from different domains. This enhanced interaction scheme may be efficient particularly when it is desired to track ads, since many third parties open their own IFrames in various websites.

Security tools allow each node in a chain of nested IFrames to know how many IFrames there are in the neighboring node above. This allows mapping all the IFrames, regardless their depth in the chain. Once the mapping of all IFrames is known, it is possible to detect all the IFrames that are linked to the same domain, so as to allow them to communicate and exchange information. For example, an IFrame can interact with another IFrame and detect on which page it appears, its location and depth in the chain of nested IFrames.

The proposed process includes two stages:

### Stage 1: The Site Tag is Served on the Web Page

During this stage, the site tag will be placed on all the pages in which the website decided to allow this type of communication. A possible implementation is that it will contain a JavaScript code that will generate an IFrame with a call to a static HTML file in the trusted domain, such as http://cdn.domain.com/sitetag.htm (different variations of this implementation are also possible).

This HTML file contains a simple JavaScript code that will allow a JavaScript code from another IFrame of the trusted domain nested within multiple IFrames to interact with it. As a result of this interaction, JavaScript code can determine the URL of the page of this website, regardless how many IFrames and domains are between them.

### Stage 2: The Site Tag is Served Inside Nested IFrames (IFrame Inside an IFrame)

During this stage, the site tag is another snippet of code from the same domain (hereinafter called an “ad tag”) that is embedded somewhere down the ad call chain. This snippet of code generates an IFrame with a call to a static HTML file in the trusted domain (http://cdn.domain.com/sitetagextract.htm).

This file contains a JavaScript code that will be able to access the IFrame in the publisher's page (embedded in the Site Tag) and communicate with it to extract the URL of the web page, as well as additional data.

### Communication Between the Site Tag and the Ad Tag

In order to communicate between these JavaScripts (the Site Tag and the Ad Tag), the two generated IFrames that belong to the “Same Trusted Domain”, the javascript option is used to iterate on the IFrame window parents property and window.frames property, since these properties are always accessible even if they are from different domain).

The security model of the JavaScript allows access the window objects that come from different domain than the one the JavaScript is running but does allow iterating on the parent windows and their IFrames (generally, trying to access properties/functions of those window objects, throws an exception).

These iteration techniques allows the JavaScript running inside the IFrame that is created near the served ad to find the IFrame window that was created by the tag served on the top page. When this JavaScript finds this IFrame window, it can access its properties because they are both hosted on the same trusted domain.

An example code for JavaScript extracting publisher URL from a generated IFrame window on the web page that is ran on the IFrame that is generated adjacent to the ad is described below:

```
var top_frames = window.top.frames;
    for (var idx = 0; idx < top_frames.length; idx++) {
        try {
            if (window.top.frames[idx].isSiteTag) {
                window.sitetagURL =
window.top.frames[idx].document.referrer;
            }
        }
        catch (e) {
        }
    }
```

This code traverses to the top window of the pages and searches for an IFrame that has an accessible SiteTag property. If such a property is found, one code extracts the referrer of that IFrame, which is the URL of the web page.

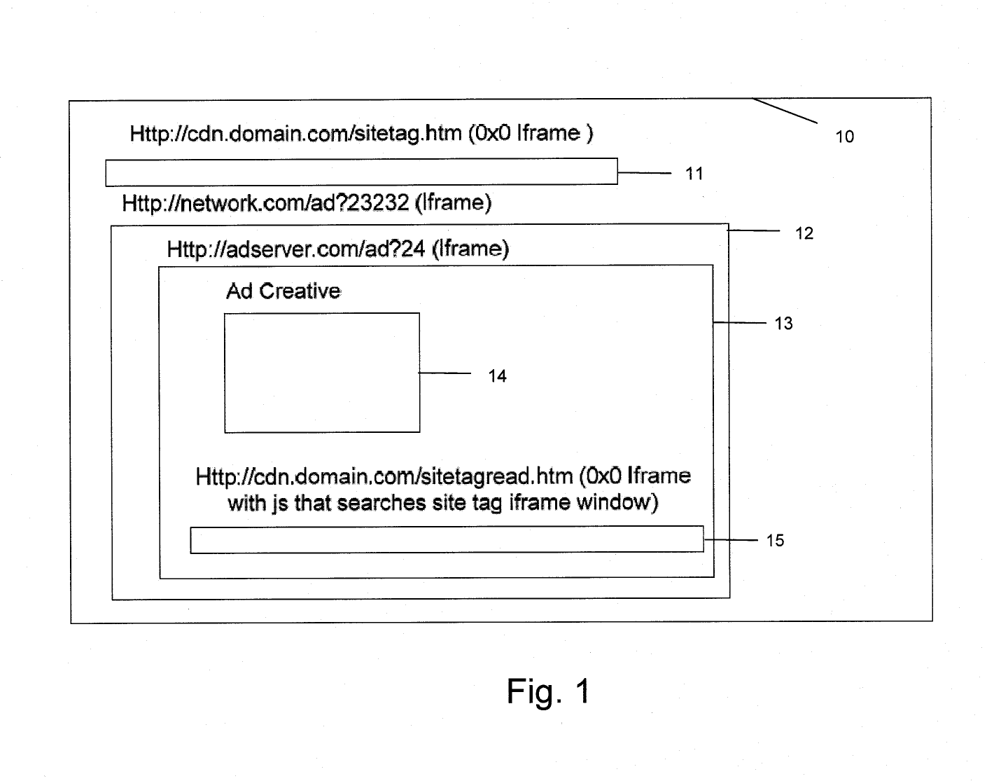

FIG. 1 illustrates an example of the layout of a web-page with a site tag on it, with two nested IFrames. The webpage includes a top page 10 http://cdn.publisher.com, to which a site tag 11 http://cdn.domain.com/sitetag.htm was added in the form of a 0x0 IFrame. The top page also includes a first nested IFrame 12 http://network.com/ad?23232, in which a second nested IFrame 13 http://adserver.com/ad?24 is embedded, where each nested IFrame belongs to a different domain. The page on the second nested IFrame 13 has an ad 14 with an ad tag 15, carried by ad 14. Ad tag 15 (represented by http://cdn.domain.com/sitetagread.htm in the form of a 0x0 IFrame) also includes a JavaScript that searches site tag's IFrame windows.

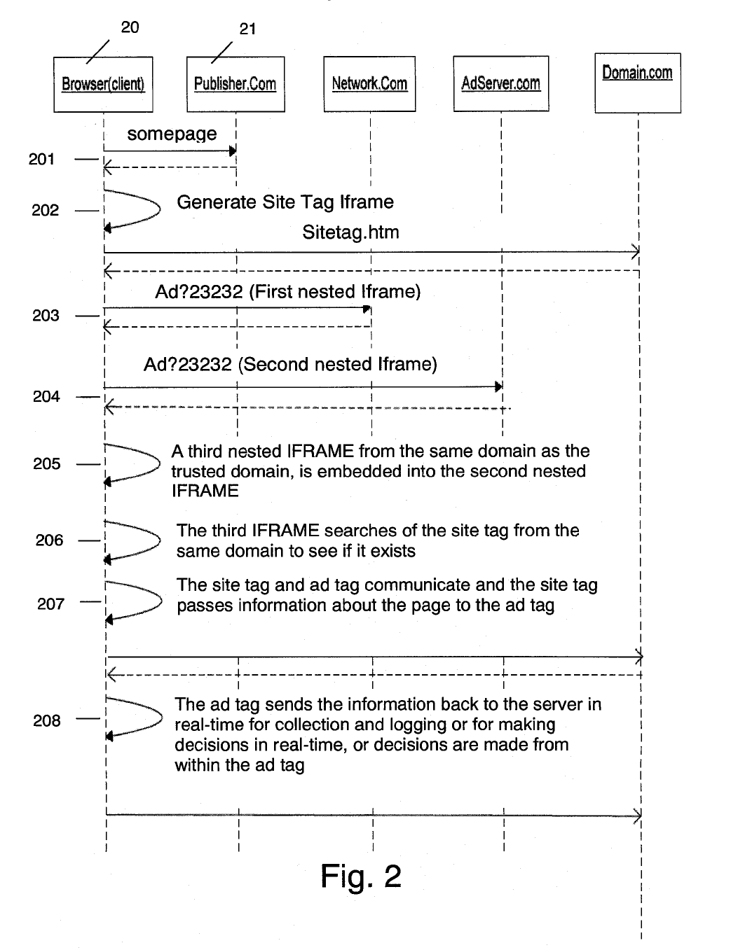

FIG. 2 illustrates the process for allowing interaction between IFrames that have the same domain. At the first step 201, the client's browser 20 submits a request for a web-page from the publisher 21 (http://Publisher.com) and in response, the top page is served to the client's browser. At the next step 202, a site tag IFrame (sitetag.htm) is generated and placed on the top page. This site tag is linked to a trusted domain (domain.com). At the next step 203, a first nested IFrame (ad?23232), which is linked to a first domain (Network.com), is embedded into the top page. At the next step 204, a second nested IFrame (ad?23232), which is linked to a second domain (Adserver.com), is embedded into the first nested IFrame. At the next step 205, a third nested IFrame from the same domain as the trusted domain (i.e, an “ad tag”) is embedded into the second nested IFrame. At the next step 206, the third IFrame (i.e., the ad tag) searches of the site tag from the same domain to see if it exists. At the next step 207, the site tag and ad tag communicate and the site tag passes information about the page to the ad tag. At the next step 208, the ad tag sends the information back to the server in real-time for collection and logging or for making decisions in real-time, or decisions are made from within the ad tag.

According to another embodiment, information can be also passed between two tags on the page, even if they are both embedded in IFrames (i.e. both are ad tags). Because they both might be embedded in different locations in the IFrame stack, both ad tags may have access to different kinds of information. The same method can be used to exchange information between them, as well.

According to a further embodiment of the present invention, it is possible to use this interaction for creating a trusted third party that is allows to place a site tag on the web page, to pass information on the page to other third parties, that otherwise would not have access to this information, to due to IFrame security limitations.

Websites often embed a JavaScript code on their web pages that from third parties such as content providers or advertising providers. Since in most cases this code arrives from a third party, this code is embedded in a way that the domain, from which the code is called, is different from the domain of the website. For example, the website's domain may be website.com, and it may have a JavaScript code embedded in its web page, which calls an advertisement server from the domain advertisement.com in order to deliver an advertisement to the web page.

When a JavaScript code is executed on a web page in the domain, from which the JavaScript code is called, is different from the domain of the web page itself (such as in the case described above), generally the browser imposes significant limitations on the JavaScript code that comes from the third party domain, and places it in a “security sandbox” (the sandbox is the program area and set of rules that programmers need to use when creating a Java code (applet) that is sent as part of a page to imply limitations on what system resources the applet can request or access). These limitations may differ based on the method used for embedding the code and the number of intermediary domains placed between the third party and the website. Those limitations, which are meant to protect the website from malicious third parties, often also limit the features and capabilities supported by legitimate third parties. Very often, a website may have a handful of different advertisements and content pieces originating from third parties and dozens of different third party “code snippets” running on the page simultaneously. Each of those “code snippets” may have different access capabilities to the page depending on where and how it is embedded in the page and how many intermediaries may be placed in the chain, which results in different features and capabilities that may be supported by those third parties. Very often, those limitations are not deliberately imposed by the website and are more a result of a number of random and deterministic factors, such as the type of implementation and the number of intermediaries involved in the ad delivery process.

As an example, a third party code snippet that is embedded “higher” in the chain (less intermediaries between it and the web page) may have access to read the URL of the webpage which is essential to provide one of its services, while another third party code snippet from the same third party and with the same function that is embedded “lower” in the chain (more intermediaries between it and the website) may not have the same access to the page URL.

According to another embodiment, by allowing multiple code snippets from the same third party on the same page to identify each other's existence and communicate with each other in real-time, it is possible to provide each other with missing data or authenticate data with one another to allow the code to fully perform its functionality. Furthermore, it allows for advanced functionality that cannot be executed when only one code snippet is on the page, or when there are multiple code snippets from the same third party that are unable to communicate with one another.

The process is performed as follows:

1) When the code snippet (otherwise known as an “ad tag”) loads on the webpage, it creates a unique page view ID number and a creation timestamp. It then creates a container such as an IFrame that will be used for tag to tag communication (will be called a T2T IFrame). The creation order is irrelevant and the page view ID is not required but helps expand the capabilities.
2) At the next step, the ad tag searches for other T2T IFrames on the page originating from the same domain that could have been created by another tag from the same third party. The browser security sandbox allows this level of communication between two IFrames on the same page if they originate from the same domain.
3) If an ad tag with a T2T IFrame finds another ad tag with a T2T IFrame on the page, they may exchange information using the T2T IFrames. For example, they may pass a name or ID of the advertiser or campaign whose ad they are delivering, or they may pass the URL of the page as they are each able to decipher. They may also decide to use a common Unique Page View ID (UPVID) for all ad tags on page, which could for example be the UPVID that has the earliest timestamp.

The following are examples of features and functionalities that may be enabled or enhanced using the described technique:

1) Ability to identify multiple ads—identifying when there are two or more ads from the same advertiser, same brand, same campaign, same placement or same flight, by each ad tag passing the advertiser ID, brand ID, campaign ID etc. to each other and checking whether they match. It may also be set up in a way in which any subsequent ad from same advertiser (or brand, or campaign) after the first one had been served will get blocked.
2) Ability to identify competitive collision—identify when there is an advertiser's ad delivered together with its competitors ad on the page by each ad tag passing the advertiser ID, brand ID to each other along with IDs of competitors and checking whether they match. It may also be set up in a way in which an ad gets blocked from serving if the competitor's ad is already on the page.
3) Ability to identify number of ads on page—by each ad tag declaring itself to the others or by using the UPVID, the number of ads delivered on the page can be counted. It can also be set up in a way in which if there are already a specified number of ads on the page, new ads get blocked.
4) Ad tags may pass the page URLs to one another to enable an ad tag that is lower in the ad chain and doesn't have visibility to page URLs to receive it from an ad tag embedded higher in the chain.
5) Comparing between the URLs the ad tags see and finding inconsistencies between them can help identify various types of advertising fraud such as undeclared URLs, injected ads or ad laundering (please define each of those); the comparison can be done on the page by the ad tags or offline by a server based on matching the UPVID.
6) Other—This mechanism may be used to identify ads that are refreshing on the page independently of a page refresh.

If one of the tags is implemented directly in the publisher domain, this increases the level of data and information it can exchange significantly.

While some embodiments of the invention have been described by way of illustration, it will be apparent that the invention can be carried out with many modifications, variations and adaptations, and with the use of numerous equivalents or alternative solutions that are within the scope of persons skilled in the art, without departing from the spirit of the invention or exceeding the scope of the claims.

1. A method for allowing enhanced interaction between an IFrame or a web page of a website that corresponds to a domain and an embedded IFrame from a different domain, comprising:
a) allowing two IFrames from the same domain that are placed on the same page to run a JavaScript code one on the other;
b) allowing said website to place a site tag, from a domain different than the web page's domain, provided to said website by a trusted third party on a top page that is not being nested within an IFrame, and further allowing any other code from said trusted third party that is delivered to said top page but is nested within one or more IFrames from different domains, to communicate with said site tag; and
c) allowing the site tag that is delivered on the top page to perform actions on behalf of an ad tag from the same domain that is nested within the IFrames.

2. A method according to claim 1, comprising:
a) placing the site tag on all the pages in which the website decided to allow communication;
b) using a first JavaScript code for generating an IFrame with a call to a static HTML file in the domain of the trusted domain;
c) allowing a second JavaScript code from another IFrame of the trusted domain nested within multiple IFrames to interact with said first JavaScript;
d) allowing the site tag to determine a URL of the page of said website;
e) serving an ad tag inside nested IFrames, said ad tag being another snippet of code from the same domain that is embedded down the ad call chain;
f) generating an IFrame with a call to a static HTML file in said trusted domain, said file contains a JavaScript code being capable of accessing said IFrame in the publisher's page; and
g) allowing the site tag to pass the page URL to the ad tag by communicating through the JavaScript.

3. A method according to claim 2, wherein the site tag is operable to extract one or more of the following parameters:
the location of the ad on the page;
the identity of the advertisers on the page;
an indication whether the ad is in the visible area of the browser;
the number of ads on page.

4. A method according to claim 2, wherein communication between the Site Tag and the Ad Tag is performed by:
a) generating IFrames that belong to the same trusted domain;
b) using JavaScripts for iterating on the parent windows and their IFrames;
c) finding the IFrame window that was created by the tag served on the top page; and
d) allowing said JavaScript to access the properties of said IFrame window.

5. A method according to claim 1, wherein interaction between IFrames that have the same domain are performed by the steps of:
a) the client's browser submits a request for a web-page from the publisher;
b) the top page is served to the client's browser;
c) a site tag IFrame, linked to a trusted domain, is generated and placed on said top page;
d) a first nested IFrame being linked to a first domain is embedded into the top page;
e) a second nested IFrame being linked to a second domain is embedded into the first nested IFrame;
f) a third nested IFrame from the same domain as the trusted domain, being an “ad tag”, is embedded into the second nested IFrame;
g) the third IFrame searches of the site tag from the same domain to see if it exists;
h) the site tag and ad tag communicate and the site tag passes information about the page to the ad tag; and
i) the ad tag sends the information back to the server in real-time for collection and logging or for making decisions in real-time, or decisions are made from within the ad tag.

6. A method according to claim 5, wherein information is passed between two ad tags on the page.

7. A method according to claim 6, wherein, both ad tags are embedded in IFrames.

8. A method according to claim 6, wherein both ad tags are embedded in different locations in the IFrame stack and have access to different kinds of information.

9. A method for allowing communication between entities from a third party domain, comprising:
a) creating a container for allowing tag-to-tag communication;
b) allowing said ad tag to search for other containers on the page originating from the same domain that could have been created by another tag from said third party; and
c) if an ad tag having a container finds another ad tag with a container on said webpage, allowing said containers to exchange information.

10. A method according to claim 9, wherein the container is a T2T IFrame.

11. A method according to claim 9, further comprising:
a) creating a Unique Page View ID (UPVID) number and a creation timestamp, whenever an ad tag loads on a webpage; and
b) using a common Unique Page View ID (UPVID) for all ad tags on the webpage, having the earliest timestamp.

12. A method according to claim 9, wherein the information passed is:
a name or ID of the advertiser or campaign, whose ad is delivered; and/or
a common UPVID for all ad tags on page.
